(19) United States
(12) Patent Application Publication
(10) Pub. No.: US 2007/0173402 A1
(43) Pub. Date: Jul. 26, 2007

(54) Method for Manufacturing High Surface Area Nano-Porous Catalyst and Catalyst Support Structures

(76) Inventors: Jan Prochazka, Zehrovice (CZ); Timothy M. Spitler, Fernley, NV (US)

Correspondence Address: SHEPPARD MULLIN RICHTER & HAMPTON LLP, 48th Floor, 333 South Hope Street, Los Angeles, CA, 90071, US

(21) Appl. No.: 11/561,759

(22) Filed: Nov. 20, 2006

Related U.S. Application Data
(60) Provisional application No. 60/738,925, filed on Nov. 22, 2005.

(51) Int. Cl. B01J 21/00

(52) U.S. Cl. 502/240; 502/300; 502/304; 502/302; 502/321; 502/324; 502/305; 502/344; 502/345; 502/349; 502/350; 502/352; 502/353; 502/355

(57) ABSTRACT

The present invention provides a process for producing high surface area, nanoporous ceramic oxide catalyst structures and catalyst structures derived from the process. In a method aspect of the present invention, a process of producing high surface area, nanoporous ceramic oxide catalyst structures is provided. The method involves the steps of: a) making an aqueous feedstock solution, wherein the solution comprises a first metal salt and a second metal salt, and wherein the first metal salt is a thermally labile metal salt, and wherein the second metal salt is a water soluble, thermally stable salt (typically an alkali metal salt); b) spray drying the feedstock solution to provide a first intermediate product; c) calcining the first intermediate product to form a second intermediate product; d) washing the second intermediate product to remove the second metal salt and form a third intermediate product; and, e) filtering and drying the third intermediate product, thereby producing a high surface area, nanoporous ceramic oxide catalyst structure with a hollow sphere morphology.

### CROSS-REFERENCE TO RELATED APPLICATION

This application claims priority to U.S. Provisional Patent Application Ser. No. 60/738,925 filed on Nov. 22, 2005, the entire disclosure of which is incorporated by reference.

### FIELD OF THE INVENTION

The present invention provides a process for producing high surface area, nanoporous ceramic oxide catalyst structures and catalyst structures derived from the process.

### BACKGROUND OF THE INVENTION

Catalyst performance is a function of accessible surface area. Scientists and researchers have accordingly pursued an increase in accessible catalyst surface area, primarily in two different ways. The first involves mounting a catalyst on a support structure, such as honeycombs, beads and fibers. This provides access to the catalyst from different angles, not simply from an exposed top surface. In the second, researchers have focused on the catalyst itself, forming materials of reduced size or of substantial porosity, such that overall surface area is significantly increased.

Some have addressed the surface area issue through the production of single and mixed oxides as nano-sized particles. U.S. Pat. No. 6,440,383, for example, discusses a hydrometallurgical process for producing ultrafine or nano-sized titanium dioxide from titanium-containing solutions, particularly titanium chloride solutions. The process is conducted by total evaporation of the solution—above the boiling point of the solution and below the temperature where there is significant crystal growth. Chemical control additives may be added to control particle size, and nano-sized elemental particles are formed after calcination.

U.S. Pat. No. 6,548,039 reports a hydrometallurgical process for producing pigment grade titanium dioxide from titanium-containing solutions. The process includes hydrolyzing the solution via complete evaporation in well-controlled conditions of temperature to form titanium oxide of well-defined characteristics. The hydrolyzing can be achieved by spray hydrolysis in a spray dryer. After hydrolyzing, the titanium oxide is calcined to transform the titanium oxide to the desired form of titanium dioxide. The titanium dioxide can be either anatase or rutile. Following calcinations, the titanium dioxide is milled to provide the desired particle size distribution and then finished.

U.S. Pat. No. 6,689,716 discusses a process for making microporous structures that can be used as a catalyst support. The process involves mixing an aqueous solution of a metal salt and a low concentration of a chemical control agent to form an intermediate solution. The solution is preferably free of any precipitate. The microporous structures have high porosity and high thermal stability, combined with good mechanical strength and relatively high surface area.

An object of the present invention is to provide a new method for producing high surface area, nanoporous ceramic oxide catalyst structures. A further object is to provide ceramic oxide catalyst structures produced using the method.

### SUMMARY OF THE INVENTION

The present invention provides a process for producing high surface area, nanoporous ceramic oxide catalyst structures and catalyst structures derived from the process.

In a method aspect of the present invention, a process of producing high surface area, nanoporous ceramic oxide catalyst structures is provided. The method involves the steps of: a) making an aqueous feedstock solution, wherein the solution comprises a first metal salt and a second metal salt, and wherein the first metal salt is a thermally labile metal salt, and wherein the second metal salt is a water soluble, thermally stable salt (i.e., stable to about 1000° C.), typically an alkali metal salt; b) spray drying the feedstock solution to provide a first intermediate product; c) calcining the first intermediate product to form a second intermediate product; d) washing the second intermediate product to remove the second metal salt and form a third intermediate product; and, e) filtering and drying the third intermediate product,

thereby producing a high surface area, nanoporous ceramic oxide catalyst structure.

In a composition aspect of the present invention, a nanoporous ceramic oxide catalyst is provided. In one embodiment, the catalyst comprises titanium, tin, molybdenum, copper, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof. The catalyst macrostructure is roughly spherical in shape and it is composed of primary particles generally between 1 nm and 500 nm in size; the surface area of catalyst particles oftentimes ranges from 50 m²/g to 300 m²/g.

### BRIEF DESCRIPTION OF THE FIGURES

FIG. 1 shows a flow diagram of a general aspect of a process for producing high surface area, nanoporous ceramic oxide catalyst structures according to the present invention.

FIG. 2 shows an XRD of a composition made according to Example 1, before and after washing.

FIG. 3 shows an XRD of a composition made according to Example 1, after calcination at 500° C. before and after washing.

FIG. 4 shows an XRD of a composition made according to Example 1, before and after calcination at 500° C. and washing.

FIG. 5 shows an XRD pattern of a spray dried LiCl treated TiOCl2 solution after calcination at 300° C. for 5 hours and after washing.

FIG. 6 shows XRD patterns describing the development of YSZ particles organized in a thin film of hollow spheres where KCl was used as the inert salt.

FIG. 7 shows a wide range XRD pattern describing the YSZ crystallinity development in the KCl salted intermediate at 500° C., 600° C., 700° C., 800° C. and 900° C.

FIG. 8 shows XRD patterns describing crystal phase development in a Na₂SO₄ treated TiOCl₂ solution, which was spray dried to produce a powder consisting of amorphous titanium dioxide and Na₂SO₄ and calcined at 300° C., 400° C., 500° C., 600° C. and 700° C.

FIG. 9 shows a graph depicting the development of porosity during the calcination of materials described in FIG. 8.

FIG. 10 shows the degree of open porosity of a ZrO2-based composition made according to the present invention.

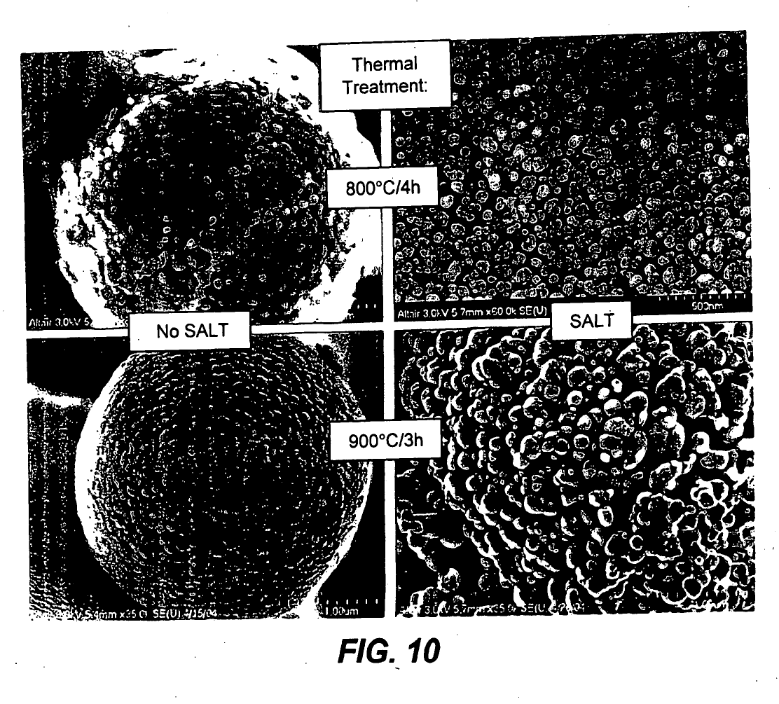

### DETAILED DESCRIPTION OF THE INVENTION

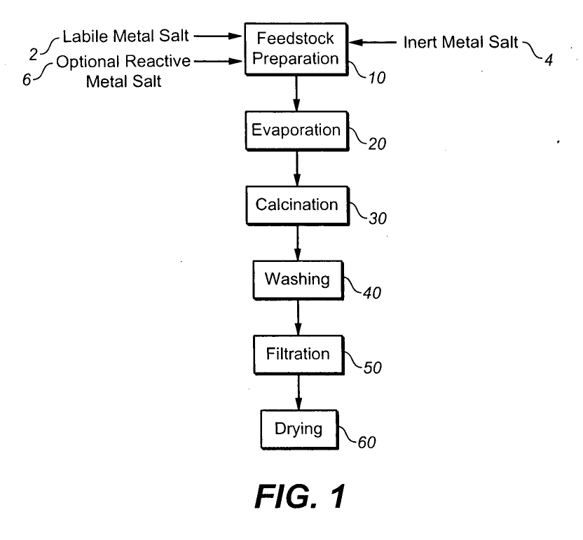

The method of the present invention is generally described in reference to FIG. 1. A feedstock solution is prepared (10) through mixing a labile metal salt (2) with an inert metal salt (4) and an optional reactive salt (6). Feedstock solution 10 is subjected to a spray drying operation (20), and the resulting solid oxide material is calcined (30). The calcined material is washed (40), typically with an aqueous solution, to remove the inert salt. It is subsequently filtered (50) and dried to provide a composition of the present invention. This method is more specifically discussed in the text below.

In one case, the feed solution used in the present invention is prepared by mixing a thermally labile metal salt (i.e., “labile salt”) with a thermally inert metal salt (i.e., “inert salt”) in an appropriate solvent, which is typically water or diluted acid. The labile salt can be any salt that thermally decomposes during a spray drying process to form an amorphous oxide. Examples of such salts include, without limitation, chlorides, oxychlorides, nitrates, nitrites, sulfates and oxysulfates of the following metals: titanium, tin, molybdenum, copper, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof. Other examples of such salts include water-soluble acetates, citrates and other thermally unstable organic compounds when used in an oxidative environment.

The inert salt is any water soluble inorganic compound that does not react with the labile metal salt in solution to form a precipitate, does not decompose during thermal processes of the present invention, and does not react with ceramic oxide at temperatures used in the present invention. The salt may even be recycled at the end of the process. Examples of such salts include, without limitation, alkali salts and mixtures thereof. The salts are preferably selected from the following: NaCl, KCl, LiCl, Na₂SO₄, K₂SO₄ and Li₂SO₄.

The concentration of inert salt in the feed solution typically ranges from 5 to 500 weight percent of the oxide created in the thermal decomposition. Preferably, the salt is present in a range from 10 to 100 weight percent, and more preferably in a ranged from 15 to 30 weight percent. Oftentimes, the anion of the thermally stable salt used in the present invention is the same as the labile salt, with a chloride-chloride combination being preferred.

In certain cases, the inert salt used in the feed solution can be created in situ rather than added. Sodium chloride, for example, can be formed through the reaction of sodium carbonate and excess HCl in a TiOCl₂ containing solution.

The feedstock solution may optionally contain a third metal salt (i.e., “reactive salt”) that is capable of reacting with the labile salt to form a mixed metal oxide. The reactive salt is typically of the formula MₓA_{y}, where the elements of the formula are as follows: M is generally an alkali earth metal (Be, Mg, Ca, Sr, Ba), scandium, yttrium, chromium, iron, nickel, or zinc; A is generally an anion; x is generally an integer between 0 and 5; and, y is generally an integer between 0 and 5.

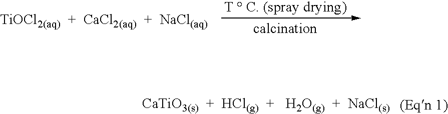

A preferred example of a reactive salt is YCl₃ in a ZrOCl₂ system producing a Y₂O₃—ZrO₂ mixed oxide. Examples of other reactive salts include, without limitation, CuCl₂, FeCl₃, ZnCl₂, NiCl₂, and LaCl₃. Lithium salts may also be used for this purpose at high temperatures. Nonlimiting examples of such lithium salts include lithium nitrate and lithium acetate, which readily react with forming TiO₂ above 500° C. in a TiOCl₂ system.

The concentration of metal in the feedstock solution is typically in a range between 10 and 200 g/L.

The feedstock solution is subjected to substantially total evaporation by contact with a hot surface or by spraying in a stream of hot gas to form an intermediate product (i.e., spray drying). Spray drying is conducted in a temperature range where the labile salt can decompose to form water insoluble, oxide solids; it is conducted at temperatures lower than required to form ceramic oxide particles organized in a defined crystal lattice. Typically, the spray drying operation is conducted between 150° C. and 350° C., preferably between 200° C. and 250° C.

The product obtained from the spray drying process is composed of hollow, thin-filmed spheres or parts of spheres. The size of the spheres may vary from about 0.1 μm to 100 μm, preferably from 5 μm to 50 μm. This intermediate product is a homogeneous mixture of an amorphous oxide and the inert salt. The spray-dried material typically contains between 1 and 30 percent volatile content that disappears in the next step—calcination.

The calcination process results in the formation of primary particles and oxide crystallinity. Crystals of the labile and inert salts fuse side-by-side (next to each other) to provide larger particles consisting of a mixture of inert salt and oxide. One can use temperature adjustments to obtain a particular oxide particle size, specific surface area, crystal phase and porosity. After calcination, the oxide particles are interlinked in a sponge-like structure.

The calcination step is generally carried out between 250° C. and 1100° C., and typically between 500° C. and 1000° C. Preferably, the calcination occurs below the melting point of the thermally stable salt.

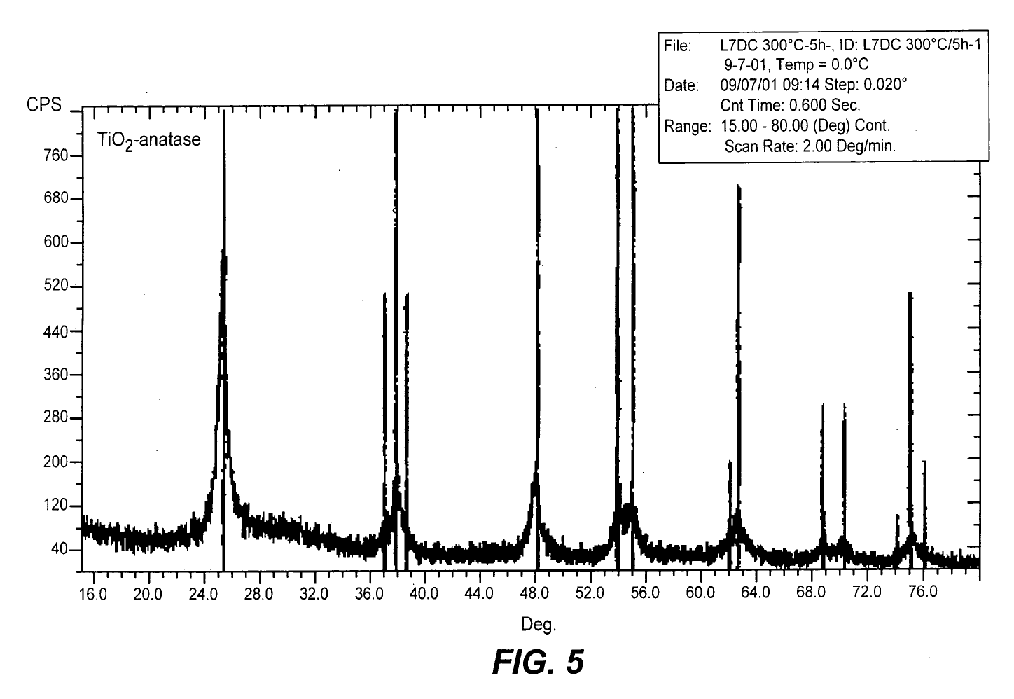

FIG. 5 presents an XRD showing YSZ particle size growth with increasing temperature. The table of FIG. 5 provides other parameters related to particle size growth, including two temperatures above the thermally stable salt melting point (KCl˜771° C.). Oftentimes, the surface area of a spray dried material is about 5 m²/g, while the same material after calcinations opens up to provide surface areas as much as two orders of magnitude greater.

One can maintain the hollow sphere macroshape of the particles during calcination. This is done by either performing the calcinations in a tray at temperatures under the melting point of the thermally stable salt or in a rotary calciner. If calcinations must occur at temperatures above the melting point of the thermally stable salt, then a rotary calciner or a fluid bed should be used to maintain the hollow, spherical structure.

The surface area of calcined material is typically in the 5 to 50 m²/g range. By washing the particles with deionized water or other suitable solvent (e.g., weak aqueous acids or weak aqueous hydroxide solutions), however, this value can oftentimes be increased substantially. In the post-calcined material, the film consisting of oxide and inert salt is compact. By placing the material in a suitable solvent, crystals of the thermally stable salt dissolve. This creates open porosity within the material, which results in an increased surface area.

The washed and salt free oxide catalyst structure is filtered in a relatively pressure free way to prevent damage to the hollow spherical macrostructure. Gravity filtration using filter paper or a membrane is typically sufficient for this operation. Alternatively, filtration and washing can be combined in a single step.

The material is then dried, making it ready for further use or processing. Drying may be performed in any suitable manner. The wet material may be placed, for example, on shelves in a drying oven, or it may be passed in continuous motion through a belt oven or a pusher oven. Another example of a drying mechanism is a rotary kiln. Spray drying can also be used to dry the oxide material.

Compositions of the present invention are metal oxides or mixed metal oxides. Where the composition is a single metal oxide, it typically comprises at least one metal component selected from the following list: titanium, tin, molybdenum, copper, beryllium, magnesium, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof. The compositions optionally comprise lithium, beryllium, magnesium, calcium, strontium, barium, scandium, yttrium, chromium, iron, nickel, or zinc.

Where the composition is a mixed metal oxide, it typically comprises at least one metal component selected from the following list: lithium, sodium, potassium, rubidium, cesium, titanium, tin, molybdenum, copper, beryllium, magnesium, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof. The compositions optionally comprise beryllium, magnesium, calcium, strontium, barium, scandium, yttrium, chromium, iron, nickel, or zinc.

The surface area of the present compositions generally ranges from 1 m²/g to 300 m²/g. Typically, the surface area ranges from 5 m²/g to 200 m²/g. For many applications, preferable surface areas are in the 50 m²/g to 200 m²/g.

The overall porosity of the compositions is typically greater than 70 percent. Oftentimes, the porosity is between 90 and 98 percent. Macroporosity is controllable from about 40 to about 95 percent of the void space. The microporosity of the oxide structure, expressed by the specific surface area, is generally 1 to 300 m²/g, with 5 to 200 m²/g being typical.

As to size and shape, the compositions tend to exist as hollow, roughly spherical particles (or partial spheres) having a thin film or shell. The size of the spheres may vary from about 0.1 μm to 100 μm, preferably from 5 μm to 40 μm.

Porous, hollow spherical structures made using the procedure of the present invention can typically adsorb liquids up to 95 percent of their volume.

Compositions of the present invention are generally used in the photocatalytic destruction of organic contaminants in air or water supplies. Other exemplary uses of the catalysts include the production of catalyst support structures for organic synthesis fog proof and as bactericides or fungicides.

YSZ compositions, among other things, can serves as thermally stable catalyst support structures.

### EXAMPLES

### Example 1

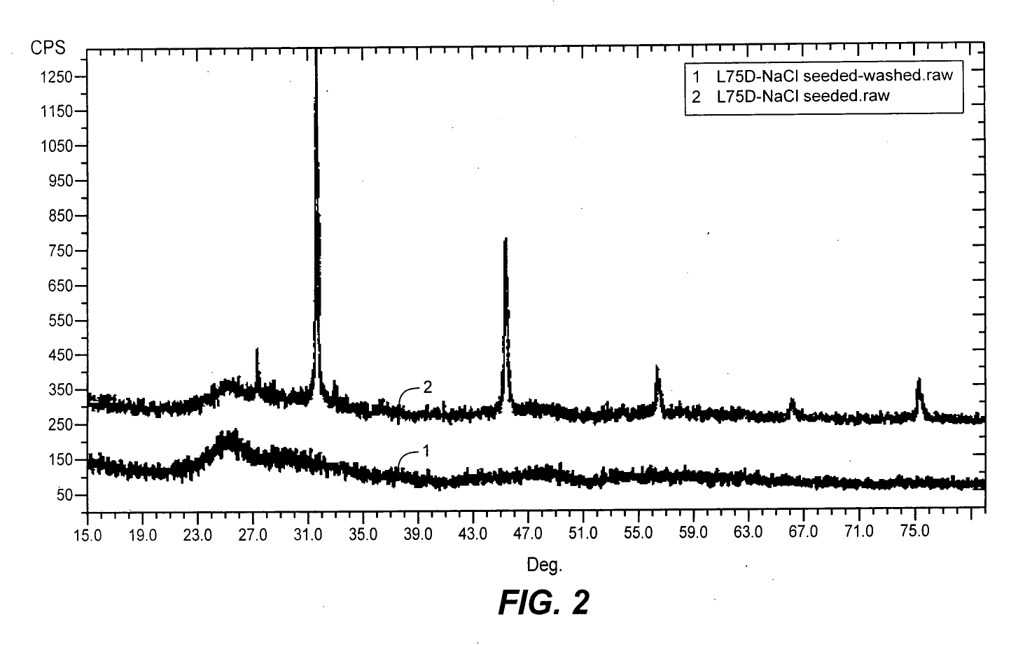

An aqueous NaCl solution was added to an aqueous TiOCl₂ solution to provide a clear solution containing about 50 g Ti (˜83 g based on TiO₂) and then NaCl was added to provide a final solution containing about 21 g NaCl/L. (The final solution contains about 104 g of pure solids.) The weight ratio NaCl/TiO₂ was 0.25. The solution was spray dried to produce hollow, spherical solids with a surface area of 12 m²/g. The TiO₂ material was organized into a sponge-like thin film, with NaCl evenly distributed through the volume of the oxide. The solids were washed with deionized water to substantially remove the NaCl from the oxide. This produced a material with an increased surface area of 65 m²/g. There was open nano-porosity throughout the material. XRD patterns of the material before and after washing are shown in FIGS. 2-4. The XRD pattern of FIG. 2 (line 2) indicates a slight overseeding with the salt. No significant TiO₂ crystal phase was present. As shown, the NaCl pattern disappears after washing (line 1), leaving only nanoclusters of mostly amorphous oxide.

### Example 2

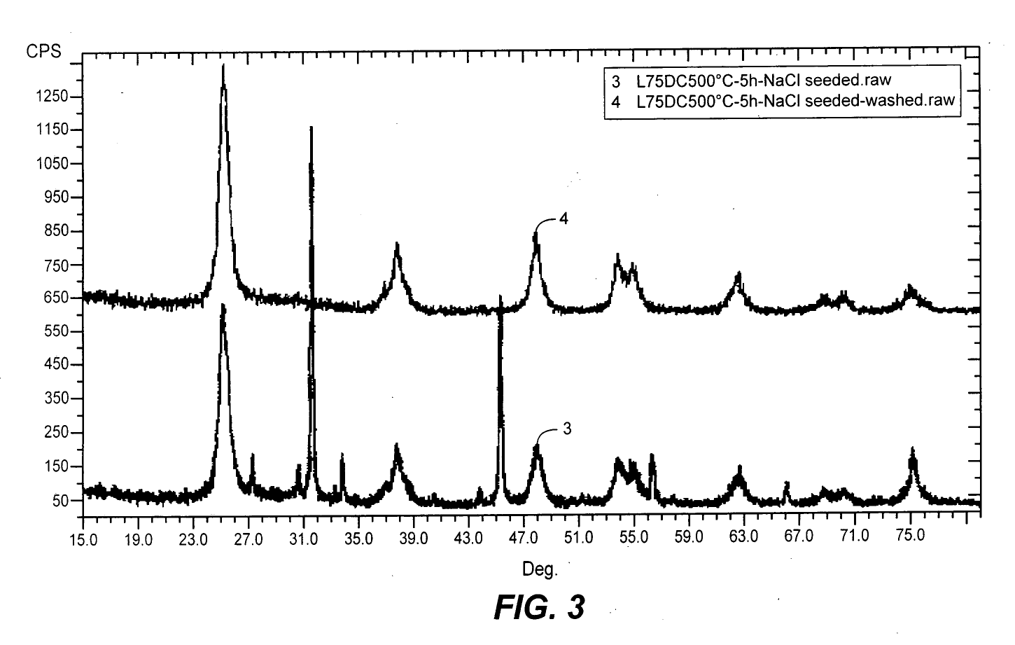

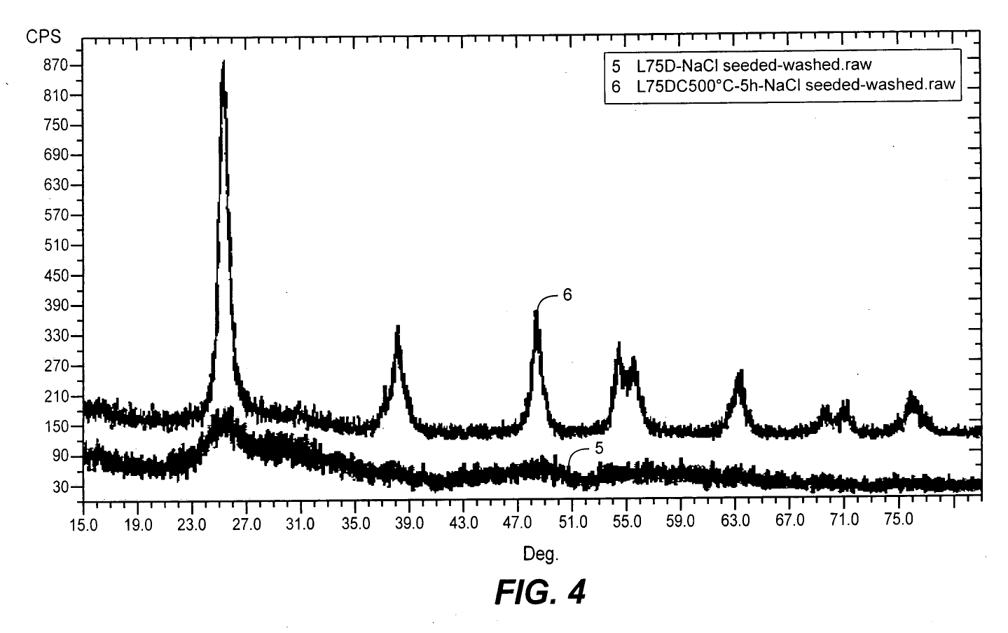

The sodium chloride-seeded, spray dryer discharge from Example 1 was calcined at 500° C. for 5 h (see FIG. 3, line 3), and the particles were washed with deionized water to remove the NaCl (see FIG. 3, line 4). During calcination, the surface area increased from 12 m²/g to 30 m²/g. The calcined material was washed with deionized water, which removed the NaCl from the particles and provided an increased surface area of 62 m²/g. The XRD patterns shown in FIG. 4 show development of TiO₂ crystallinity after the calcination (see line 5) compared to nearly amorphous TiO₂ before calcination (see line 6). As a comparison, the typical surface area of comparable TiO₂ material calcined at 500° C. for 5 hours in the absence of NaCl is 15-20 m²/g.

### Example 3

An aqueous LiCl solution was added to an aqueous TiOCl₂ solution to provide a slightly yellow liquid containing about 50 g Ti, and then LiCl was added such that a molar ration Li/Ti of 4:5 was provided. The liquid was spray dried and then calcined at 300° C. for 5 h. The salts were washed with deionized water, and the catalyst structure was dried to provide a material with a surface area of 205 m²/g. (See XRD pattern in FIG. 5). The insoluble TiO₂ material was organized in a porous, thin film of hollow spheres. Washed salts created a nanoporous labyrinth of sponge-like porosity throughout the oxide film. Anatase crystalline particles about 7 nm in diameter were formed during calcination. The structure has pore sizes similar to the sizes of primary particles of the oxide.

### Example 4

An aqueous LiNO₃ solution was added to an aqueous TiOCl₂ solution to provide a clear solution containing about 40 g Ti, and then LiNO₃ was added such that a molar ration Li/Ti of 4:5 was provided. The solution was spray dried and calcined at 300° C. for 5 h. The salts were washed with deionized water, and the catalyst structure was dried to provide a material with a surface area of 147 m²/g. The insoluble TiO₂ material was organized into a porous, thin film of hollow spheres. This created a porous, labyrinth-like effect through the thin film. Anatase crystal phase developed during calcination; all pores were open and accessible. The material was calcined at 400° C. for 4 h and 500° C. for 3 h in the absence of salts. This resulted in significant surface area reduction—from 147 m²/g to 30 m²/g as the particles grew bigger. The mesoporous character of the oxide, however, was preserved.

### Example 5

An aqueous KCl solution was added to an aqueous TiOCl₂ solution to provide a solution containing about 70 g Ti, and KCl was added such that a weight ratio KCl/TiO₂ of 0.25 was provided. The solution was spray dried and calcined at 300° C., which produced particles having a surface area of 14 m²/g. The particles were washed with dionized water, and the resulting powder was dried. The product surface area was increased from 14 m²/g to 207 m²/g. An analysis showed that there was approximately 500 ppm of potassium in the product.

### Example 6

A titanium oxychloride solution containing 110 g Ti/L was treated with a NaCl—KCl—LiCl eutectic composition. The melting point of the salt composition was about 346° C. The total amount of added eutectic composition was 20 weight percent of the amount of Ti in solution. This amount corresponds to 12 weight percent of the equivalent amount of TiO₂—i.e., the TiO₂ that will be formed from the solution in the process. The solution was evaporated in a spray drier at 250° C., which produced a salted titanium, inorganic amorphous intermediate. The intermediate was calcined at 300° C. for 7 h. TiO₂ particles with a specific surface area of 140 m²/g were obtained after washing.

### Example 7

An aqueous KCl solution was added to an aqueous ZrOCl₂ solution to provide a solution containing about 50 g Zr, and KCl was added such that a weight ratio KCl/ZrO₂ of 0.25 was provided. The solution was spray dried at 250° C. to produce a solid, amorphous intermediate. The intermediate was calcined at 500° C., 600° C., 700° C., 800° C. and 900° C., and the resulting particles were washed with deionized water. There was a difference in porosity for the calcined materials, as compared side-by-side with unsalted material otherwise calcined under the same conditions. At 600° C. and higher, there was a ZrO₂ early phase transformation from cubic to monoclinic, even though particle size was very small. In the case of growing the nanoparticles from a molecular distance, salt crystals work as a template for organizing oxide molecules in a crystalline particle.

### Example 8

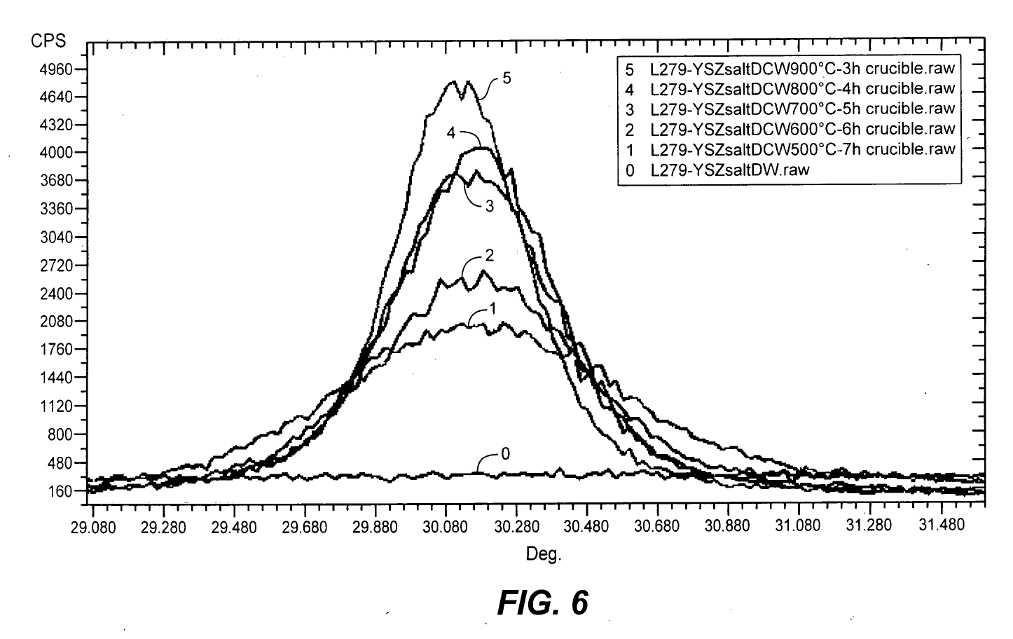

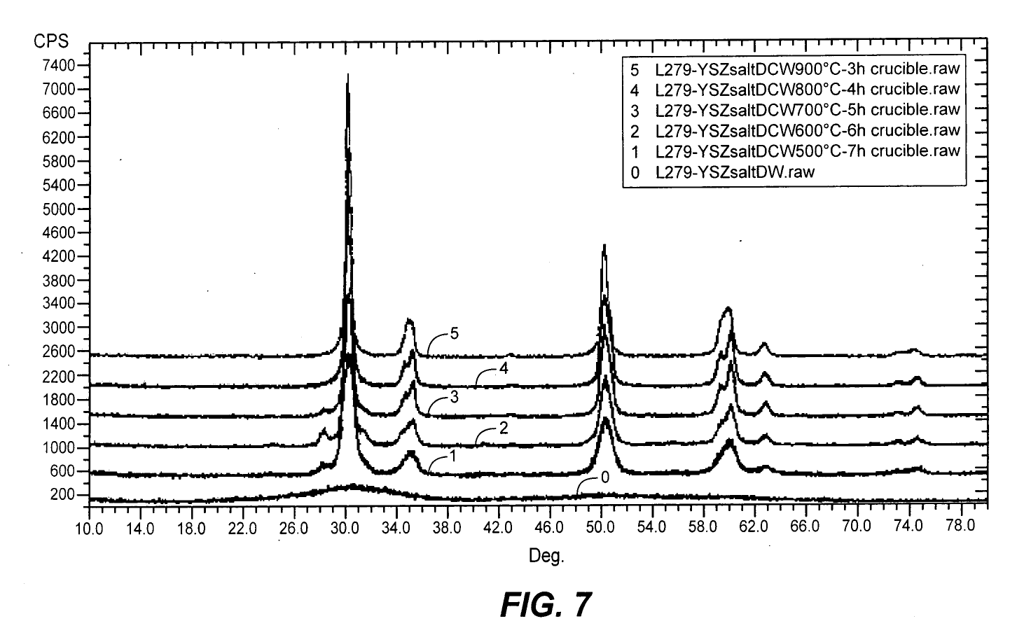

An aqueous solution of ZrOCl₂ and YCl₃, in a stoichiometric ratio of 8 mol percent of Y₂O₃ in ZrO₂, was mixed with an aqueous KCl solution. The final solution contained about 50 g Zr/L. KCl was added in an amount of 25 weight percent based on the ZrO₂ content. The solution was spray dried and calcined at 500° C./7 h, 600° C./6 h, 700° C./5 h, 800° C./4 h and 900° C/3 h. The particles were then washed with deionized water. The surface areas of the calcined materials were, respectively, 77 m²/g, 63 m²/g, 54 m²/g, 51 m²/g and 28 m²/g. Crystallinity and particle size development was apparent from XRD graphs FIGS. 6 and 7 and data shown in Table 1 below. The materials possessed excellent milling properties, as compared to materials prepared without salt. The materials were milled to primary particles. The hollow sphere structure no longer existed in the milled material, and the particles were nearly completely milled and dispersed.

TABLE 1

| | | | | | | PS- |
|---|---|---|---|---|---|---|
| YSZ-Salt | Particle | | | Particle | Particle | XRD/BET |
| Dried, Calcined, | Size-XRD | BET | SG | Size-BET | Size-SEM | Agreement |
| Washed | (nm) | (m²/g) | (g/cm³) | (nm) | (nm) | (%) |
| YSZ-DC-500° C./7 h-W | 10 | 77 | 5.5 | 14 | 10 | 70 |
| YSZ-DC-600° C./6 h-W | 13 | 63 | 5.6 | 17 | 10-15 | 76 |
| YSZ-DC-700° C./5 h-W | 17 | 54 | 5.5 | 20 | 15-20 | 85 |
| YSZ-DC-800° C./4 h-W | 17 | 51 | 5.6 | 21 | 20 | 81 |
| YSZ-DC-900° C./3 h-W | 19 | 28 | 5.9 | 37 | 30-40 | 52 |

### Example 9

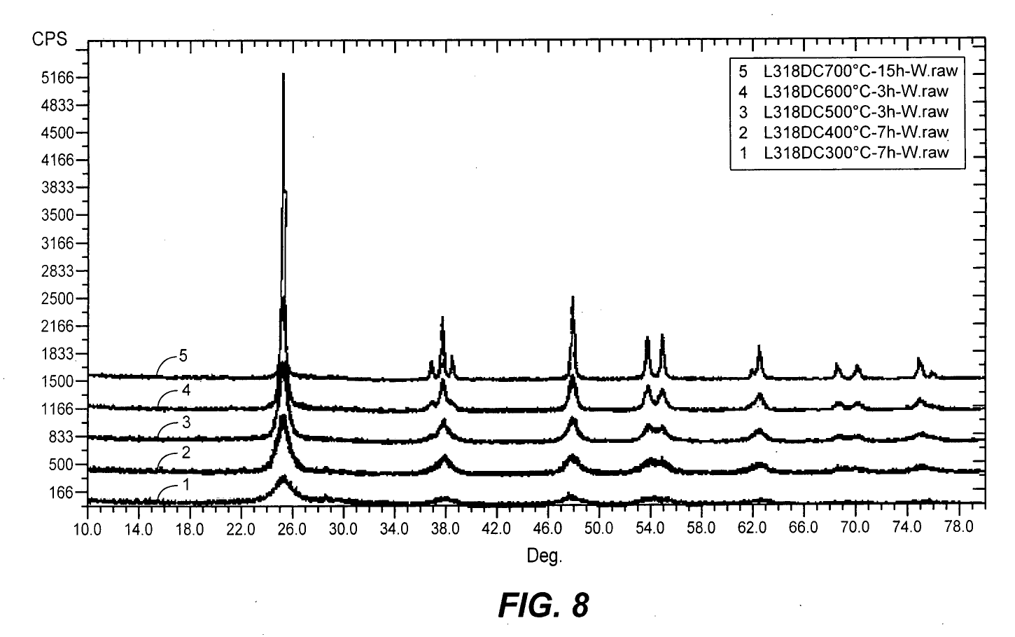

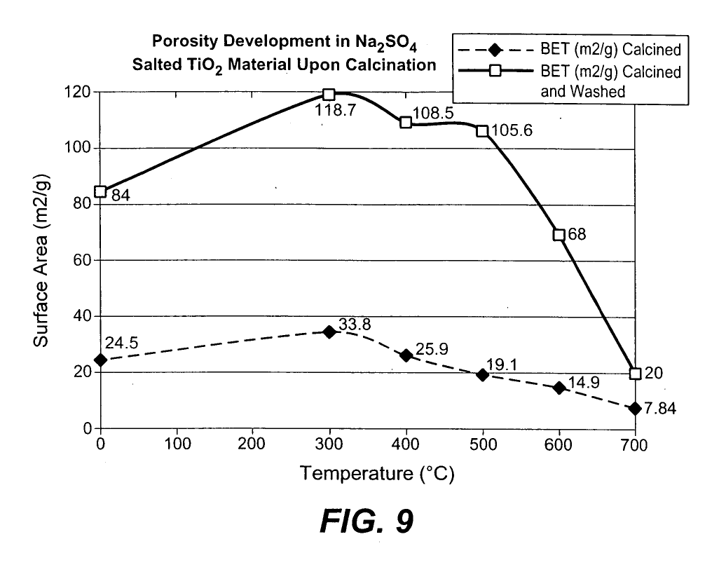

A titanium oxychloride solution containing 130 g Ti/L was treated with a Na₂SO₄ salt. The total amount of thermally stable, inert salt eutectic composition added was 20 weight percent of the amount of TiO₂ in solution. The solution was evaporated in a spray drier at 250° C., which produced a salted, titanium dioxide inorganic, amorphous intermediate. The intermediate was further calcined at 300° C., 400° C., 500° C., 600° C., 700° C. and 800° C. No rutile crystal phase was present at 800° C. Corresponding XRD patterns of the materials shown in FIG. 8 indicated the presence of crystal phase and particle development. FIG. 9 presents the degree of open porosity development and particle size growth as expressed in surface area numbers. TiO₂ particles were produced having a specific surface area of 119 m²/g (calcinations at 300° C. and washing).

### Example 10

An aqueous solution of ZrOCl₂ and YCl₃, in a stoichiometric ratio of 8 mol percent of Y₂O₃ in ZrO₂, was mixed with and aqueous solution of nickel salt, in a ratio of 8 mol percent NiO in YSZ. KCl was added in an amount of 25 weight percent. The solution was spray dried at 250° C. and calcined at 700° C. and 900° C. The particles were washed with deionized water to remove the KCl salt. Because EDX analysis indicated separation of YSZ and NiO phases, the materials were leached in hydrochloric acid and washed again. The surface areas of the leached materials increased slightly from 19 m²/g to 21 m²/g (700° C.) and 8 m²/g to 9.5 m²/g (900° C.). The remaining Ni concentration in YSZ after leaching was under 500 ppm, confirming the split of phases.

1. A producing high surface area, nanoporous ceramic oxide catalyst structures, wherein the process comprises the steps of:
a) making an aqueous feedstock solution, wherein the solution comprises a first metal salt and a second metal salt, and wherein the first metal salt is a thermally labile metal salt, and wherein the second metal salt is a thermally stable salt;
b) spray drying the feedstock solution in an oxidative atmosphere to provide a first intermediate product;
c) calcining the first intermediate product in an oxidative atmosphere to form a second intermediate product;
d) washing the second intermediate product to remove the second metal salt and form a third intermediate product; and,
e) filtering and drying the third intermediate product,
thereby producing a high surface area, nanoporous ceramic oxide catalyst structure.

2. The method according to claim 1, wherein the first metal salt is selected from a group of soluble metal salts consisting of chlorides, oxychlorides, nitrates, nitrites, sulfates and oxysulfates of the following metals: titanium, tin, molybdenum, copper, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof.

3. The method according to claim 1, wherein the second metal salt is a thermally stable alkali metal salt or mixtures thereof.

4. The method according to claim 1, wherein the aqueous feedstock solution further comprises a third metal salt of the formula MₓA_{y}, wherein the elements of the formula are as follows: M is scandium, yttrium, chromium, iron, nickel, or zinc; A is an anion; x is an integer between 0 and 5; and, y is an integer between 0 and 5.

5. The method according to claim 1, wherein the evaporation step is performed in a spray drying operation.

6. The method according to claim 1, wherein the calcining step is performed at a temperature between 250° C. and 1000° C.

7. The method according to claim 1, wherein the spray drying step is performed at a temperature between 200° C. and 250° C.

8. The method according to claim 1, wherein the concentration of the second metal salt in the feedstock solution is from 15 to 30 weight percent.

9. The method according to claim 1, wherein the concentration of metal in the feedstock solution is between 1 g/L and 200 g/L.

10. The method according to claim 2, wherein the second metal salt is selected from a group of metal salts consisting of NaCl, KCl, LiCl, Na₂SO₄, K₂SO₄ and Li₂SO₄.

11. The method according to claim 10, wherein the evaporation step is performed at a temperature between 200° C. and 250° C.

12. The method according to claim 11, wherein the calcining step is performed at a temperature between 500° C. and 1000° C.

13. The method according to claim 12, wherein the concentration of the second metal salt in the feedstock solution is from 15 to 30 weight percent.

14. The method according to claim 13, wherein the first metal salt is either a titanium salt or a zirconium salt.

15. A nanoporous ceramic oxide catalyst, wherein the catalyst comprises titanium, tin, molybdenum, copper, silica, germanium, aluminum, gallium, vanadium, hafnium, yttrium, niobium, tantalum, bismuth, lead, cerium, tungsten, cobalt, manganese, arsenic, zirconium, praseodymium, neodymium, promethium, samarium, europium, gadolinium, terbium, dysprosium, holmium, erbium, thulium, ytterbium, lutetium and mixtures thereof, and wherein the catalyst is roughly spherical in shape and is between 0.1 μm to 100 μm in size, and wherein the surface area of catalyst particles ranges from 1 m²/g to 300 m²/g.

16. The catalyst according to claim 15, wherein the overall porosity of the catalyst is between 40 and 98 percent.

17. The catalyst according to claim 15, wherein the catalyst structures are hollow.

18. The catalyst according to claim 15, wherein microporosity of the catalyst structure ranges from 1 to 300 m²/g.

19. The catalyst according to claim 15, wherein the catalyst comprises titanium or zirconium.

20. The catalyst according to claim 19, wherein the surface area of catalyst particles ranges from 5 m²/g to 300 m²/g.

21. The catalyst according to claim 20, wherein the overall porosity of the catalyst is between 40 and 98 percent.

22. The catalyst according to claim 21, wherein microporosity of the catalyst structure ranges from 5 to 200 m²/g.
